(19) United States
(12) Patent Application Publication
(10) Pub. No.: US 2004/0209018 A1
(43) Pub. Date: Oct. 21, 2004

(54) Modular panel

(76) Inventor: Theodore W. Lookholder, Los Angeles, CA (US)

Correspondence Address: James E. Brunton, Esquire, 700 N. Brand Blvd., Suite 860, Post Office Box 29000, Glendale, CA, 91203, US

(21) Appl. No.: 10/414,916

(22) Filed: Apr. 15, 2003

(51) Int. Cl. B32B 3/06; B32B 7/08; B32B 9/00

(52) U.S. Cl. 428/33; 428/52; 428/192; 428/223

(57) ABSTRACT

A modular panel that can be used for multiple purposes and one that can be interconnected with other articles and with similar modular panels by means of a versatile fastening system. The modular panel includes a flexible planar body having spaced-apart edges, reusable fastening components positioned along at least one of the spaced-apart edges of the flexible planar body and a plurality of reusable fastening components positioned intermediate the spaced-apart edges of the flexible planar body.

### BACKGROUND OF THE INVENTION

1. Field of the Invention

The present invention relates generally to modular panel systems. More particularly, the invention concerns a modular panel of novel design that can be used alone or in combination with similar panels to construct a wide variety of useful articles.

2. Discussion of the Prior Art

A wide variety of covering systems has been suggested in the past. The most common of these is the canvas or plastic tarpaulin that is used to construct various types of structures and to cover various articles and protect them from the elements. Such coverings are made in various sizes and, of course, different sizes are required depending upon the area that is to be covered. If the area to be covered is larger than the size of the particular tarpaulin at hand, then disadvantageously, a larger tarpaulin must be acquired or multiple smaller tarpaulins must be used to cover the area. As a general rule, no provision is made to easily interconnect or separate tarpaulins.

Modular panels have been used in the past for the construction of articles of clothing. For example, U.S. Pat. No. 5,592,691 issued to Ronald, entitled Modular Panel for Fabricating Clothing and Accessories, discloses a modular panel comprising a flexible planar sheet form body with peripheral edges. Zippers are positioned along each of the four peripheral edges. The zippers along the peripheral edges of the body enable the peripheral edges to be mated with each other or other bodies to form articles of clothing and clothing accessories.

The thrust of the present invention is to provide a modular panel of unique design that can be used for multiple purposes and one that can be interconnected with other articles and with similar modular panels by a novel, highly versatile fastening system to form various types of modular panel systems.

### SUMMARY OF THE INVENTION

It is an object of the present invention to provide a modular panel of unique design that can be used for multiple purposes and one that can be interconnected with other articles and with similar modular panels by means of a novel, highly versatile fastening system.

Another object of the invention is to provide a modular panel of the aforementioned character that includes a flexible planar body having spaced-apart edges, reusable fastening means positioned along each of the spaced apart edges of the flexible planar body and a plurality of reusable fastening means positioned intermediate the spaced apart edges of the flexible planar body.

Another object of the invention is to provide a modular panel as described in the preceding paragraphs that can be readily interconnected with one or more similarly constructed modular panels to form protective coverings of various sizes.

Another object to the invention is to provide a modular panel of the class described that can be a connected with other articles, such as a specially designed backpack, to form an auxiliary article storage area.

Another object of the invention is to provide a modular panel as described in the preceding paragraphs that can be folded upon itself to form an emergency stretcher.

Another object of the invention is to provide a modular panel system that comprises a plurality of modular panels of the class described that can be interconnected together to form a plurality of booth like enclosures that can be used as product display areas at trade shows and the like.

### BRIEF DESCRIPTION OF THE DRAWINGS

FIG. 1 is a front view of one form of the modular panel of the present invention.

FIG. 2 is a view taken along lines 2-2 of FIG. 1.

FIG. 3 is a generally diagrammatic front view illustrating the manner by which the modular panel shown in FIG. 1 can be removably interconnected with a second modular panel of similar construction.

FIG. 4 is a view taken along lines 4-4 of FIG. 3.

FIG. 5 is a greatly enlarged diagrammatic view illustrating the manner of interconnection of one form of the reusable fastening means of the present invention.

FIGS. 6A and 6B when considered together show the appearance of the panels shown in FIGS. 3 and 4 when interconnected together.

FIGS. 7A and 7B when considered together show still another form of the modular panel of the present invention wherein reusable fastening means are provided on both the front and back surfaces of the panel.

FIGS. 8A and 8B when considered together comprise a view taken along lines 8-8 of FIGS. 7A and 7B.

FIG. 9 is a front view of another form of modular panel of the present invention that is interconnectable with the modular panel shown in FIGS. 7A and 7B.

FIG. 10 is a view taken along lines 10-10 of FIG. 9.

FIG. 11 is a fragmentary diagrammatic view illustrating the manner of interconnection of the panel shown in FIG. 9 with the panel shown in FIGS. 7A and 7B.

FIG. 12 is a fragmentary diagrammatic view similar to FIG. 11 further illustrating the manner of operation of the reusable fastening means of the invention to interconnect the panel shown in FIG. 9 with the panel shown in FIGS. 7A and 7B.

FIG. 13 is a top plan view of a partition type construction that can be formed through the interconnection of a plurality of modular panels of the character shown in FIG. 9 with the modular panel of the character shown in FIGS. 7A and 7B.

FIG. 14 is a generally perspective exploded view of an alternate form of panel construction of the present invention in which the modular panel of the invention is used in the construction of a backpack.

FIG. 15 is a view of the backpack construction as it appears following interconnection of the modular panel of the invention with the body portion of the backpack.

FIG. 16 is a generally diagrammatic view illustrating the manner of use of the reusable fastening means in interconnecting the modular panel with the body of the backpack.

FIG. 17 is a view taken along lines 17-17 of FIG. 16.

FIG. 18 is a top plan view of still another form of the modular panel assembly of the invention showing an individual positioned on a modular panel of the assembly.

FIG. 19 is a generally prospective view showing the modular panel assembly of FIG. 18 being used as an emergency stretcher.

FIGS. 20A and 20B when considered together comprise a cross-sectional view taken along lines 20-20 of FIG. 18.

FIGS. 21A and 21B when considered together comprise a view taken along lines 21-21 of FIGS. 20A and 20B.

FIG. 22 is an enlarged, fragmentary cross-sectional view of the upper portion of the assemblage shown in FIG. 19.

FIG. 23 is a view taken along lines 23-23 of FIG. 22.

FIG. 24 is a view similar to FIG. 23, but showing the tracks of the zipper assembly being interconnected through the use of the slider mechanism.

FIG. 25 is a back view of an alternate form of the invention shown here as an article of clothing embodying interconnectable modular panels that enable the size of the garment to be readily adjusted.

### DESCRIPTION OF THE INVENTION

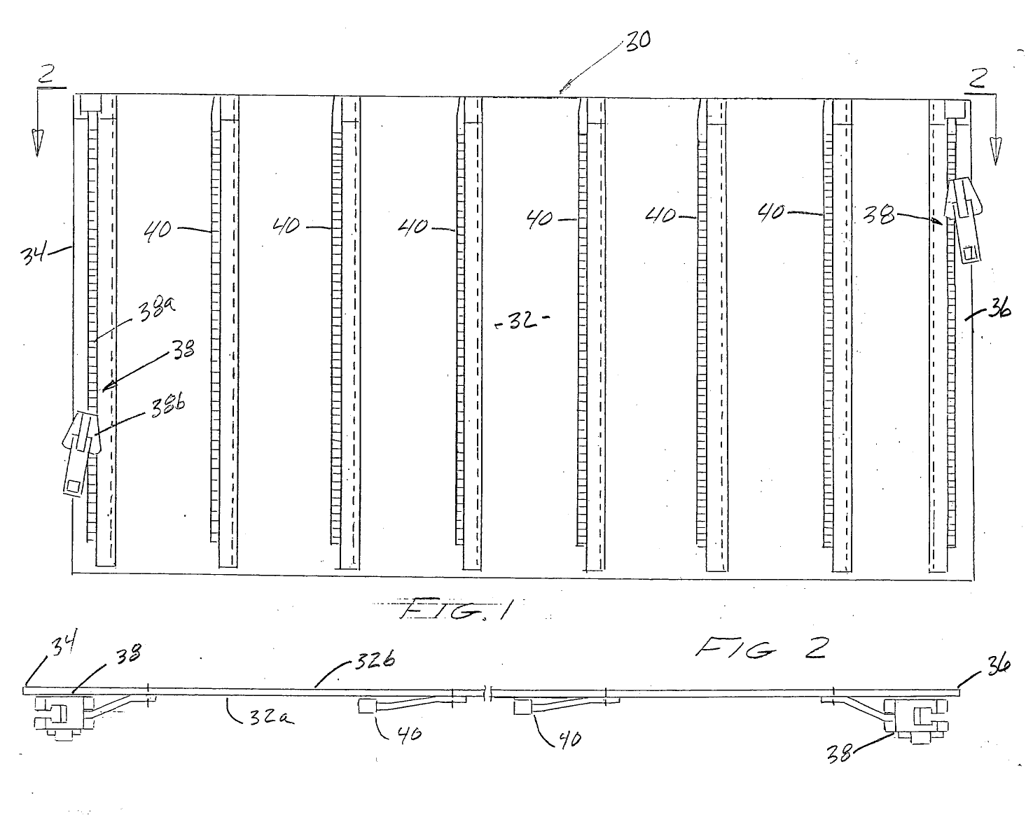

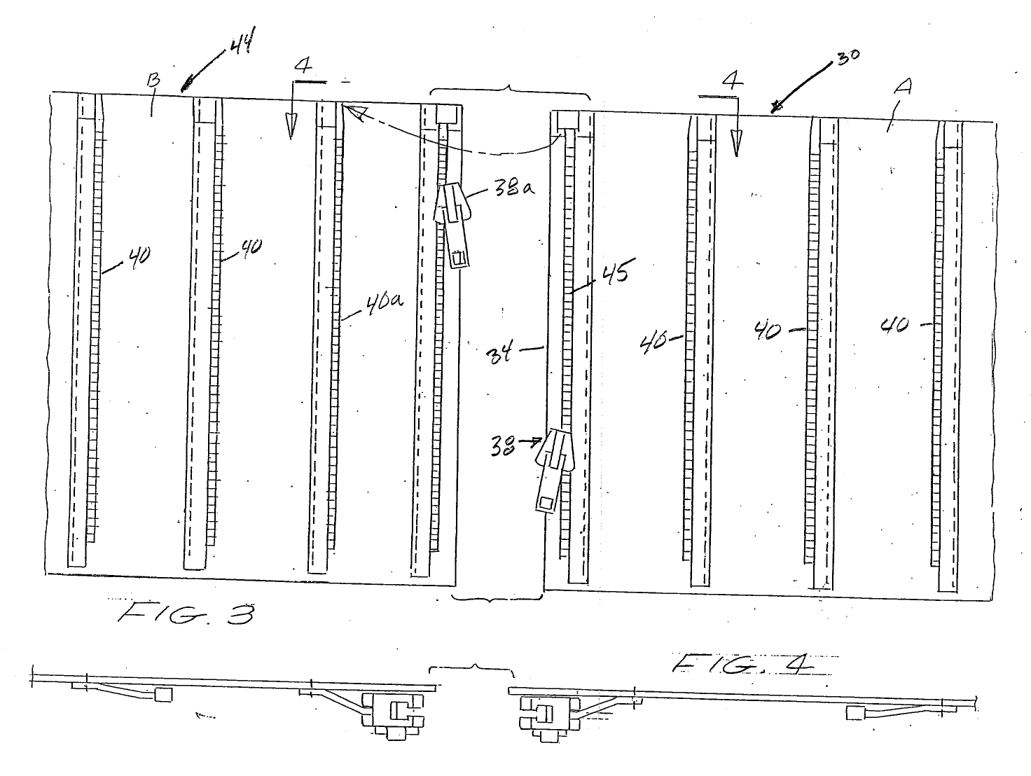

Referring to the drawings and particularly to FIGS. 1 and 2, one form of the modular panel of the invention is there shown in generally designated by the numeral 30. Modular panel 30 comprises a flexible planar body portion 32 having transversely spaced apart edges 34 and 36. Positioned along each of the spaced apart edges 34 and 36 are reusable fastening means here shown as conventional zipper components 38. Fastening means, here shown as zipper components 40 are also positioned intermediate the spaced apart edges of the flexible planar body. As illustrated in FIG. 2, flexible planar body 32 has front and rear surfaces 32a 32b respectively. In the present form of the invention the fastening means are interconnected with the front surface 32a of the planar body 32.

Zipper component 38 comprises a conventional zipper track 38a and a conventional sliding piece 38b. Zipper component 40 comprises a conventional zipper track that can be matably interconnected with zipper track 38a. In the conventional prior art zipper assembly two cooperating zipper tracks are provided, each being made up of two rows of metal or plastic teeth that are affixed to strips of tape. Each of the teeth comprises a hook portion and a hollow portion. When the zipper is closed by the sliding piece, every hook on each of the two tracks is wedged into a hollow on the opposite track. The sliding piece is merely a collection of wedges. As the slide moves upwardly of the track the, two teeth strips must enter at a specific angle. As the strips move through the slide, the slide's cific angle. As the strips move through the slide, the slide's inclined edges push the teeth toward each other. The strips are offset from each other, so each hollow settles onto a hook in sequence. In most commercially available, prior art zippers, the interlocking teeth form a very secure bond making it extremely difficult to separate the teeth by pulling the two strips apart. However, the slide can easily separate the teeth, using a simple plow-shaped wedge. When the slide is pulled down, the wedge pushes against the slanted edges of the hooks, pivoting each tooth off of the tooth below it. The zipper track is typically constructed of metal chain, molded plastic chain or nylon chain. In a conventional prior art zipper construction, two devices (the bottom stop) are affixed to the bottom end of a zipper, to prevent the slider from coming off the chain. Similarly, a device called the bottom stop is affixed to the bottom end of a zipper to prevent further movement of the half of the zipper from separating.

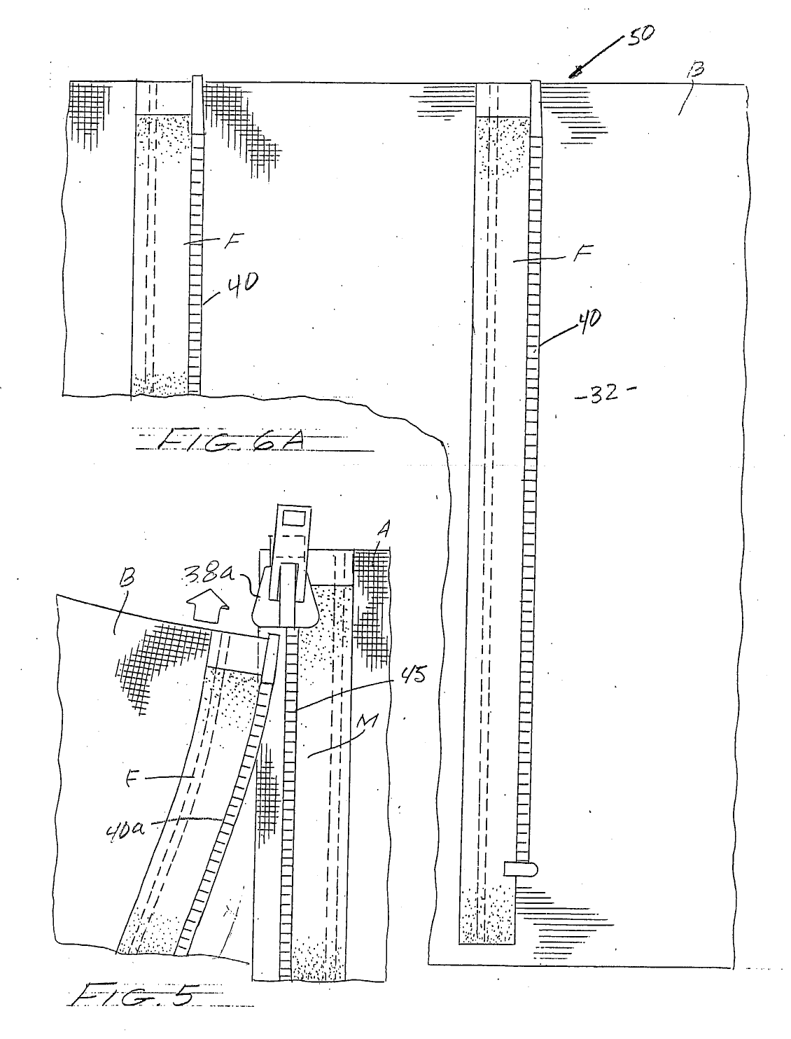

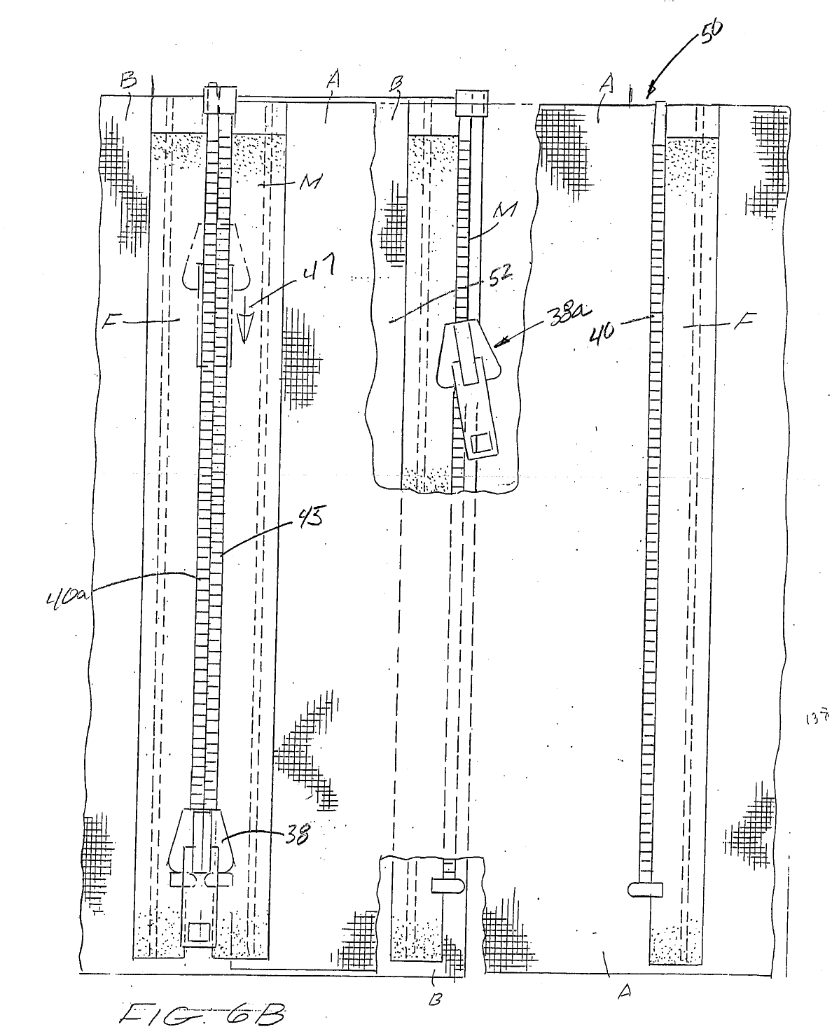

Referring now to FIGS. 3 and 4, one form of the modular panel system is there illustrated. More particularly, this system comprises panel assembly 30 and a second panel assembly generally designated by the numeral 44. Panel assembly 44 is a similar construction to panel assembly 30 and like numerals are used to identify like components. Panel assembly 30 can be interconnected with panel assembly 44 by interconnecting the track designated as 40a in FIG. 3 with the track designated as 45 in FIG. 3. Interconnection of the tracks 40a and 45 is accomplished in the manner illustrated in FIG. 5 through use of the slider 38. More particularly, after the upper end of track 40a is inserted into slider 38, movement of the slider downwardly in the direction of the arrow 47 in FIG. 6b will result in the secure interconnection of panel assembly 30 with panel assembly 44 to form an enlarged covering 50. Indicated in FIG. 6B, when the modular panels are interconnected, the edge portion 52 of panel assembly 44, along was slider 38a of second panel 44 would be overlapped by edge portion 34 of panel assembly 30. It is, of course, apparent that if the length of the covering needs to be adjusted, an alternate track 40 can be interconnected with panel assembly 44. In this way longer or shorter panel systems can easily be constructed. In a similar manner, if the covering needs to be enlarged, as for example to cover a specific area, one or more additional modular panels can be interconnected to panel assembly 50 in the same manner as previously described herein. The assemblage formed of interconnected panel assemblies 30 and 50 can be used for a wide variety of purposes. For example, the assemblage may be used to cover the cargo bed of a truck, it can be draped over a horizontally extending support to form a tent-like shelter or it can be used for any purpose for which a conventional tarpaulin may be used. By adjusting the overall length of the panel system, the covering can be tailor made to cover a truck bed of specific size; or if an adjustable bodywrap is desired, the size of the wrap can be readily adjusted.

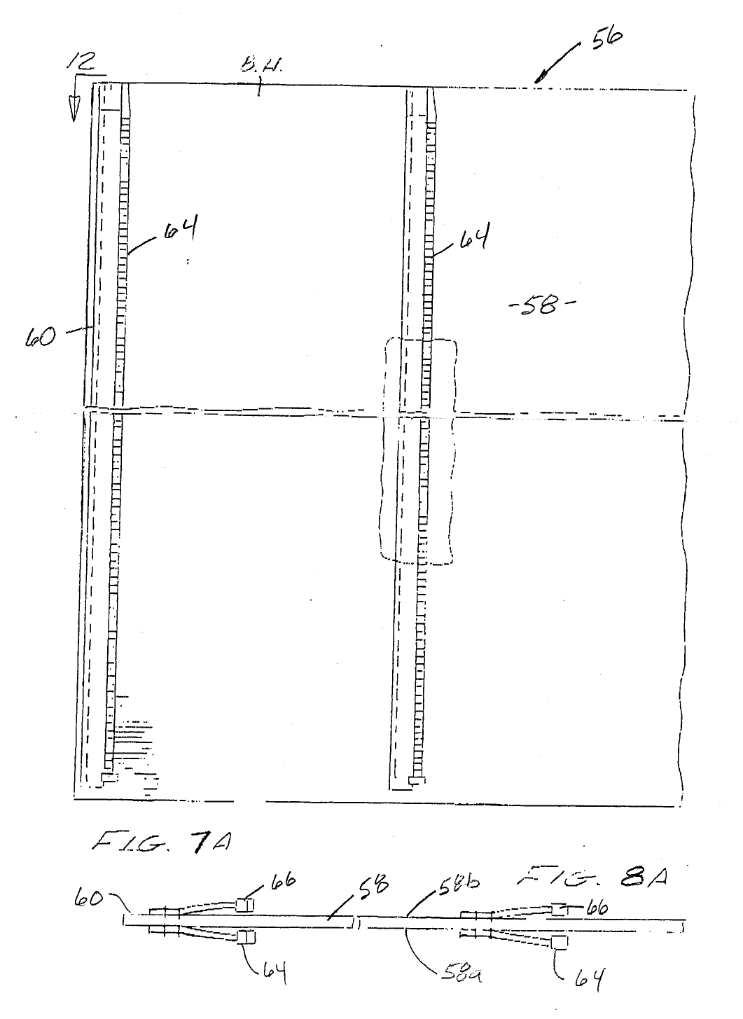

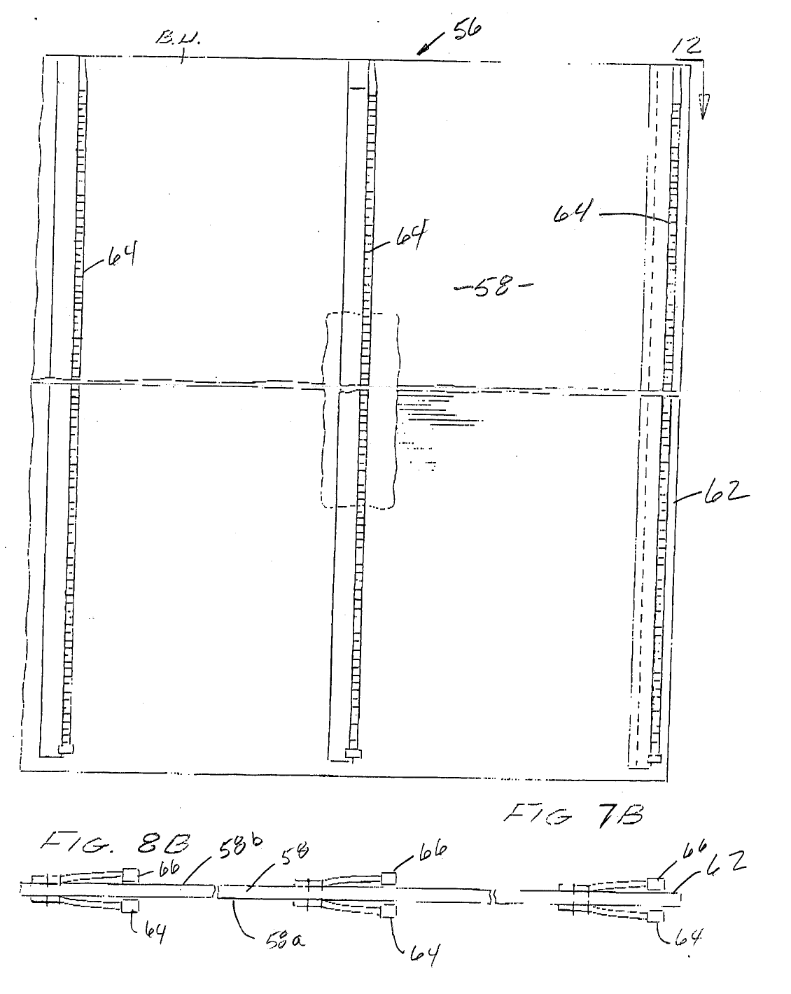

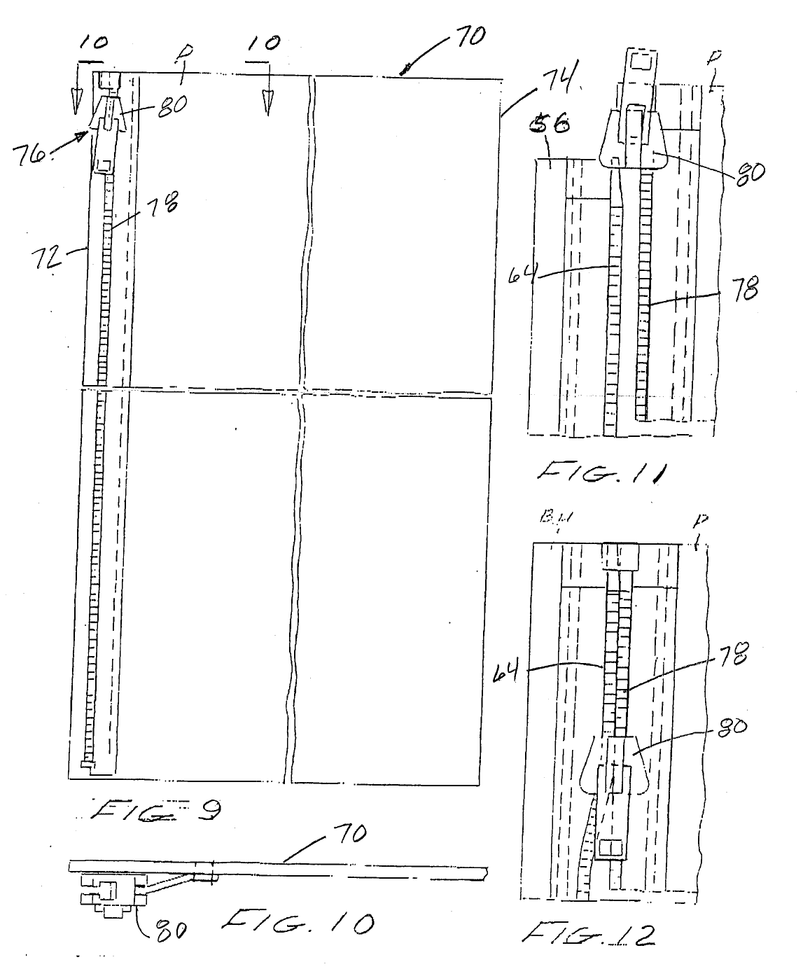

Turning next to FIGS. 7 through 13, an alternate form of the modular panel of the invention is there shown and generally designated by the numeral 56. Modular panel 56 is similar in construction to the modular panel shown in FIGS. 1 through 6 and can be used for like purposes. As illustrated in FIGS. 7A, 7B, 8A and 8B, modular panel 56 comprises a flexible planar body portion 58 having front and back surfaces 58a and 58b respectively and transversely spaced-apart edges 60 and 62. Positioned along each of the spaced-apart edges 60 and 62 are first reusable fastening means of the character previously described and identified in the drawings as conventional zipper tracks 64. Second reusable fastening means comprising zipper components, or tracks 64, are also positioned intermediate the spaced apart edges of the flexible planar body 58.

In this latest form of the invention second fastening means are provided on both the front and rear surfaces of the planar body 58 (FIGS. 8A and 8B). More particularly, transversely spaced apart, conventional zipper tracks 64 are provided on the first or front surface 58a of the planar body, while conventional zipper tracks 66 are provided on the second or rear surface 58b of the planar body. Zipper tracks 64 and 66 are of the same construction and operation as the earlier described zipper tracks 40.

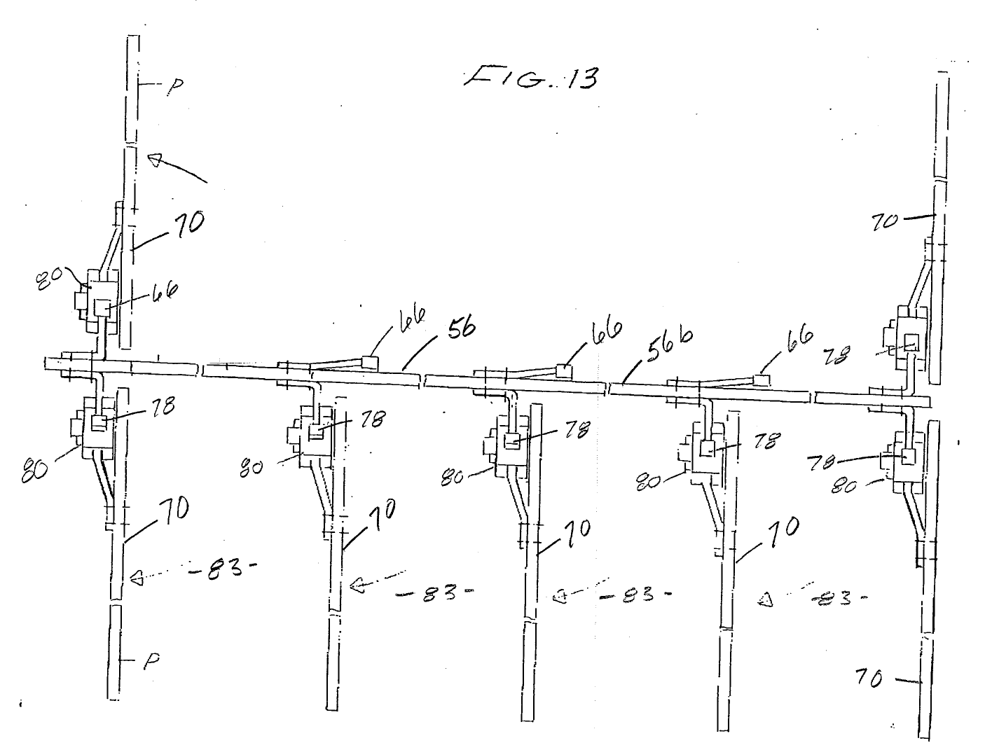

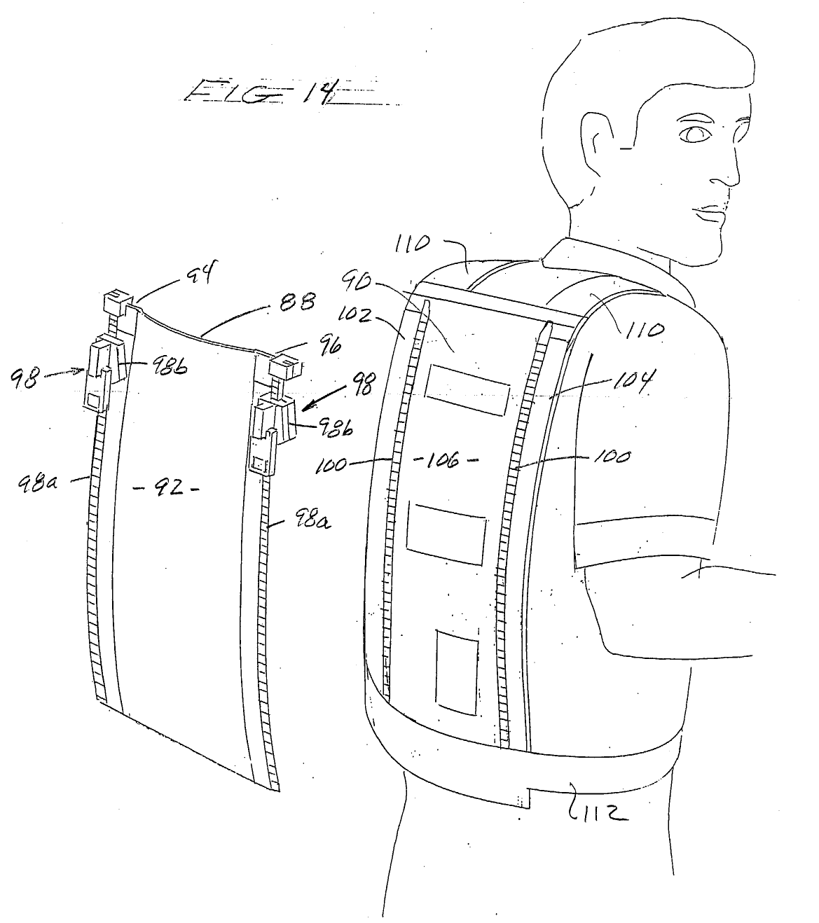

Referring also to FIGS. 9 and 10, a second panel assembly, which is generally designated by the numeral 70, can be interconnected with modular panel assembly 56 in a manner presently to be described. Modular panel assembly 56 has transversely spaced apart first and second edges 72 and 74 respectively. Affixed proximate first edge 72 is a zipper component, generally designated by the numeral 76. Zipper component 76 includes a track 78 and a slider 80, which is operable in the same manner as the previously described slider 38. As illustrated in FIGS. 11 and 12, a selected track 64 of panel 56 can be interconnected with track 78 through operation of slider 80 in the manner previously described and as illustrated in FIG. 12.

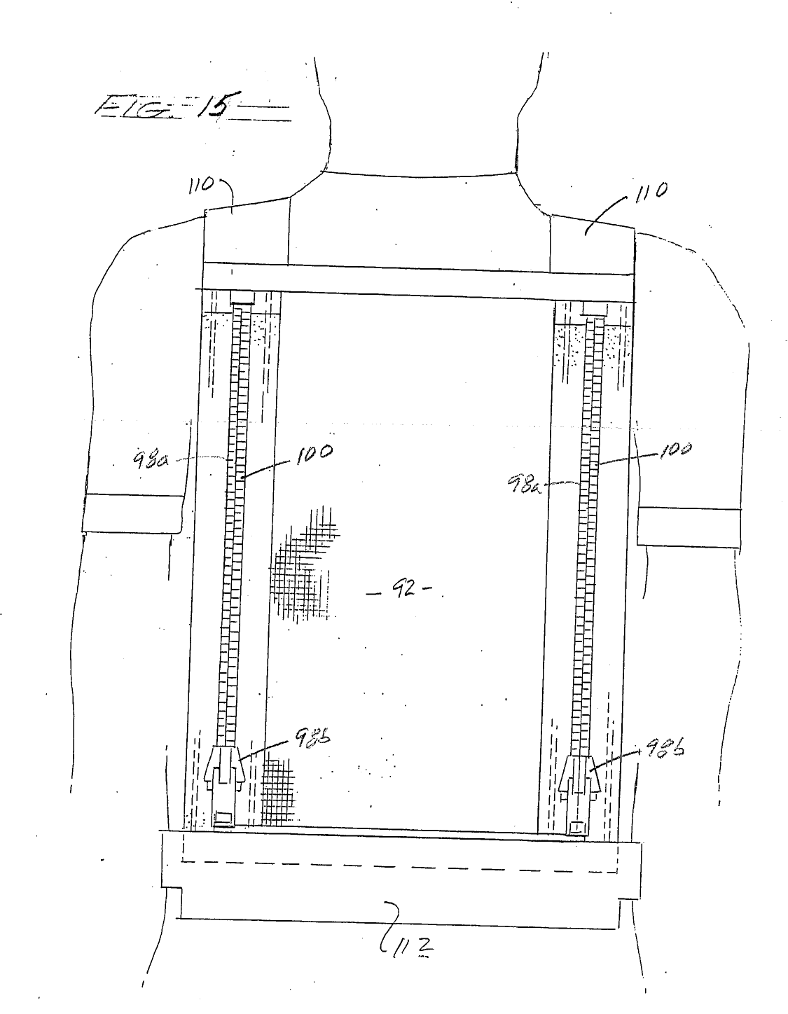

Referring to FIG. 13, an alternate form of modular panel system of the invention is there illustrated. This system comprises panel assembly 56 and a plurality of outwardly extending second panel assemblies 70 that are selectively interconnected with the transversely spaced apart tracks 64 and 66 of panel assembly 56. Interconnection of the tracks 64 and 70 of the second panels is accomplished in the manner illustrated in FIGS. 11 and 12 through use of the slider 80 of zipper components 76. More particularly, after the upper end of a selected track 64 is inserted into slider 80 of a second panel assembly 70, movement of the slider downwardly in the manner illustrated in FIG. 12 will result in the secure interconnection of the selected panel assembly 70 with panel assembly 56 to form a part of an assembly of the character illustrated in FIG. 13. When a number of second panel assemblies 70 are interconnected with panel assembly 56 in the manner shown in FIG. 13, a plurality of booth like areas 83 are formed. These areas can be used for various purposes as, for example, work areas, dressing areas or display areas for displaying products at trade shows and the like.

As previously mentioned, and as indicated in FIGS. 7A, 7B and 13 the backside 56B of panel assembly 56 is provided with a plurality of spaced apart track components 66. When it is desired to construct back-to-back booth like areas, second panel assemblies 70 can be interconnected with tracks 66 in the manner previously described.

Turning next to FIGS. 14 through 17, still another form of the modular panel system of the present invention is there illustrated. This form of the invention, which comprises a backpack like construction that can be worn by an individual in the manner shown in FIG. 14, includes a first and second cooperating modular panels 88 and 90. Modular panel 88 is somewhat similar to the previously described modular panel 30 and comprises a flexible planar body portion 92 having transversely spaced-apart edges 94 and 96. Positioned along each of the spaced-apart edges 94 and 96 are reusable fastening means here shown as conventional zipper components 98. Fastening means, here shown as zipper components 100 are also positioned proximate the spaced-apart edges 102 and 104 of the flexible planar body 106 of second modular panel 90.

Each zipper component 98 comprises a conventional zipper track 98a and a conventional sliding piece 98b.

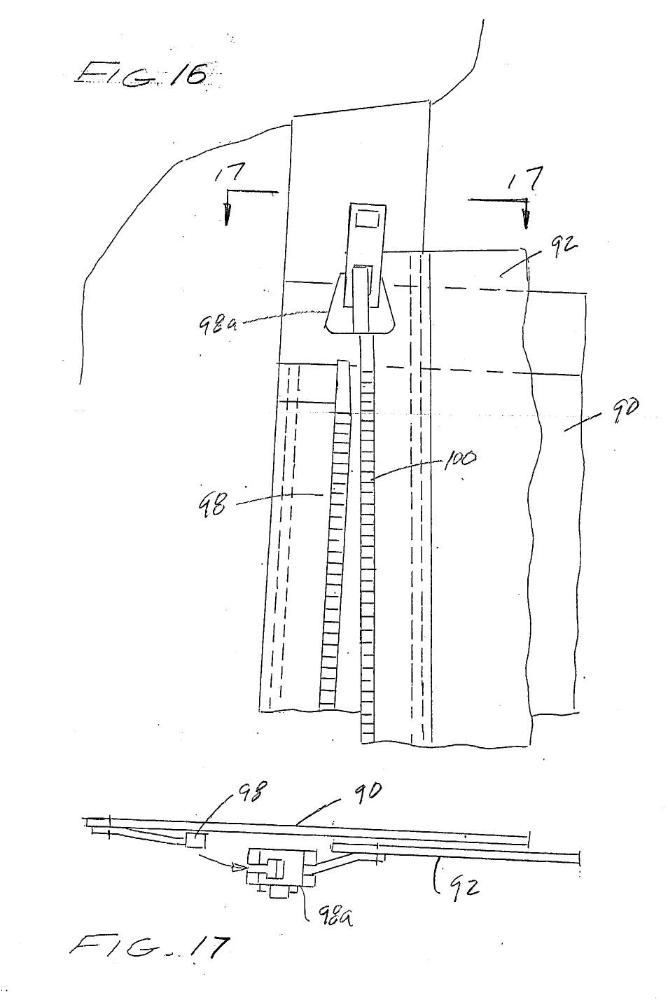

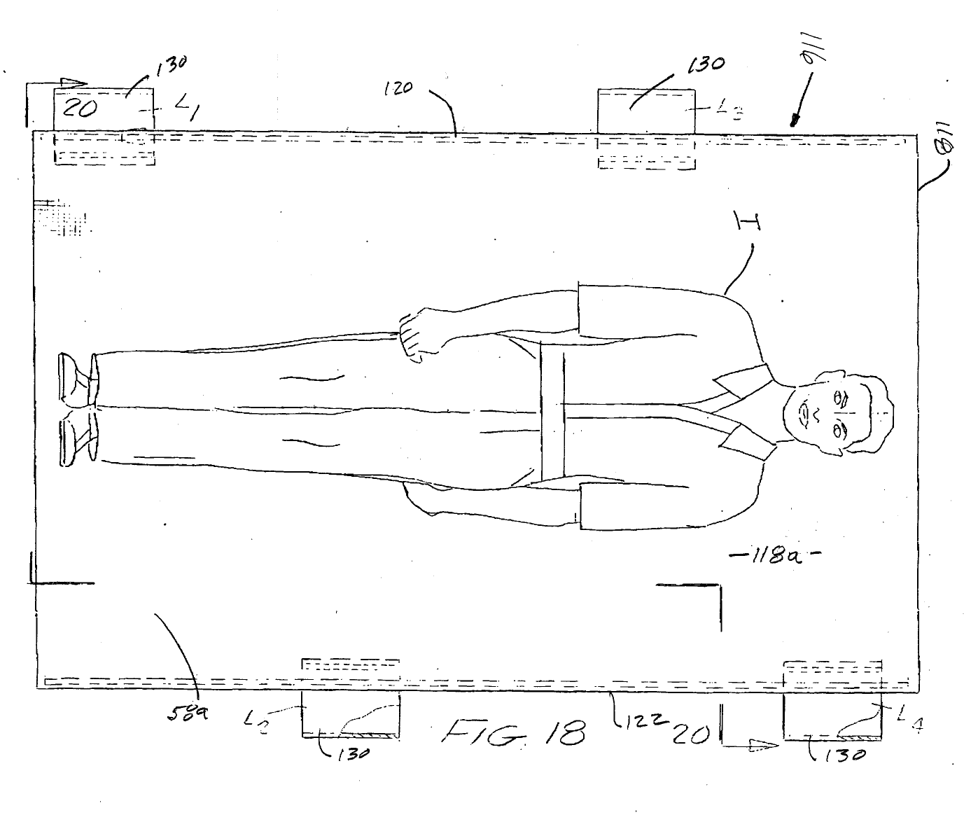

In this latest form of the invention, panel 90 is interconnected with shoulder straps 110 and with a belt like member 112 so that the panel can be donned by a user in the manner shown in FIG. 14. When so donned, the assemblage can be used for warmth as a vest-like article of clothing. Alternatively, the article can be converted into a backpack-like structure by interconnecting tracks 98a with tracks 100 using slider 98b in the manner shown in FIG. 15 so as to form an article placement enclosure located intermediate the first and second panels. Interconnection of the tracks 98a and 100 through use of slider 98 is accomplished in the conventional manner illustrated in FIGS. 16 and 17 of the drawings.

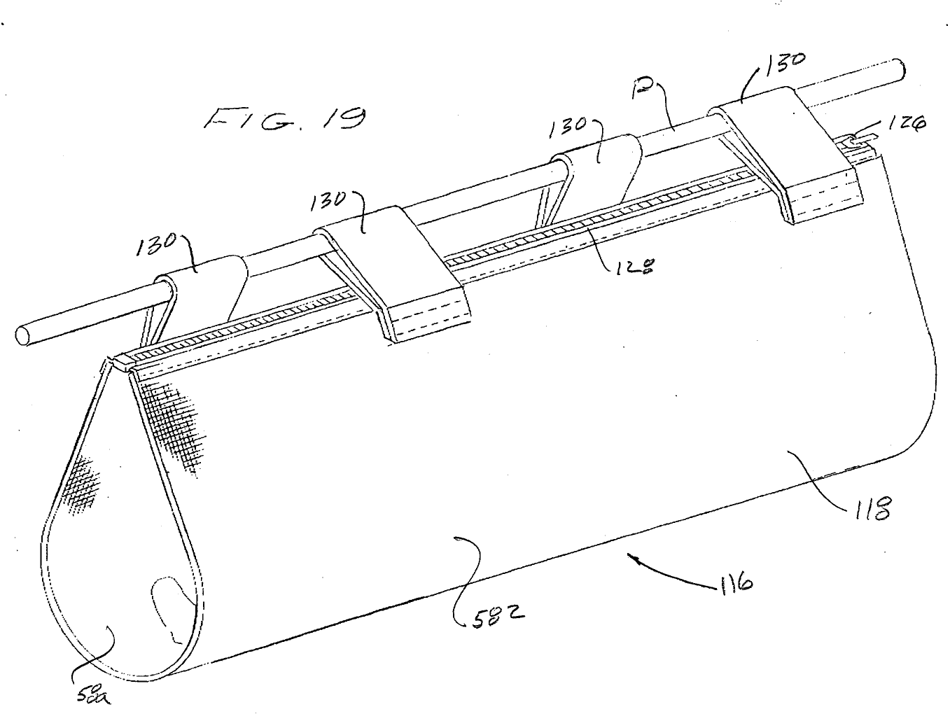

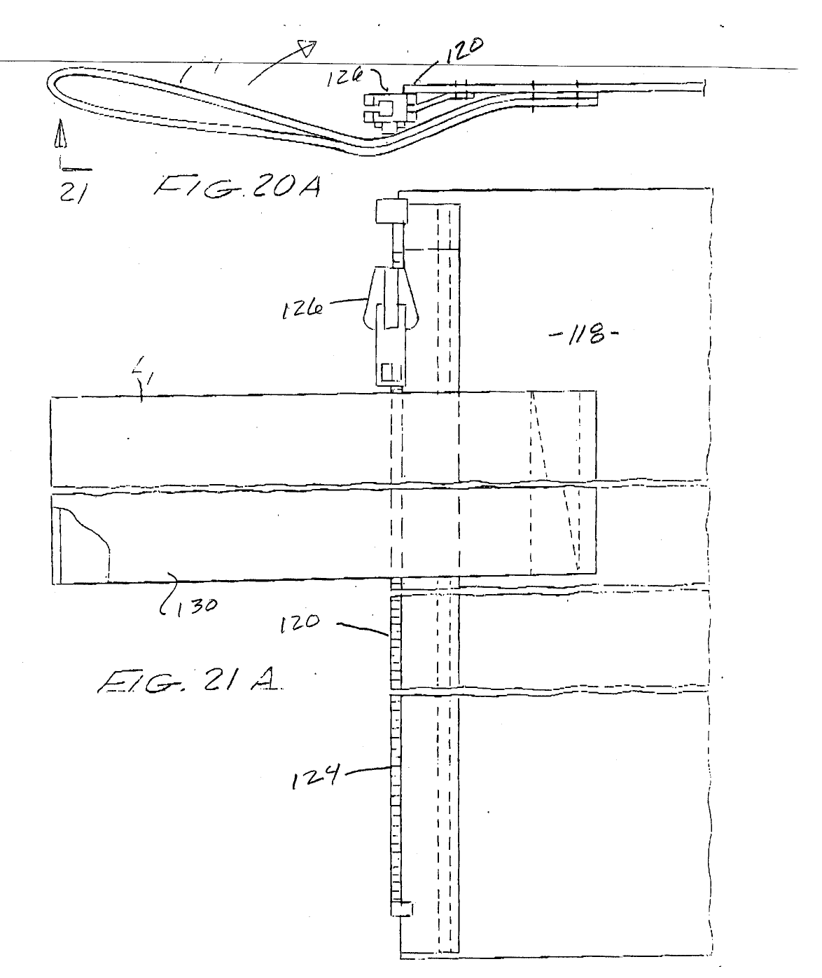

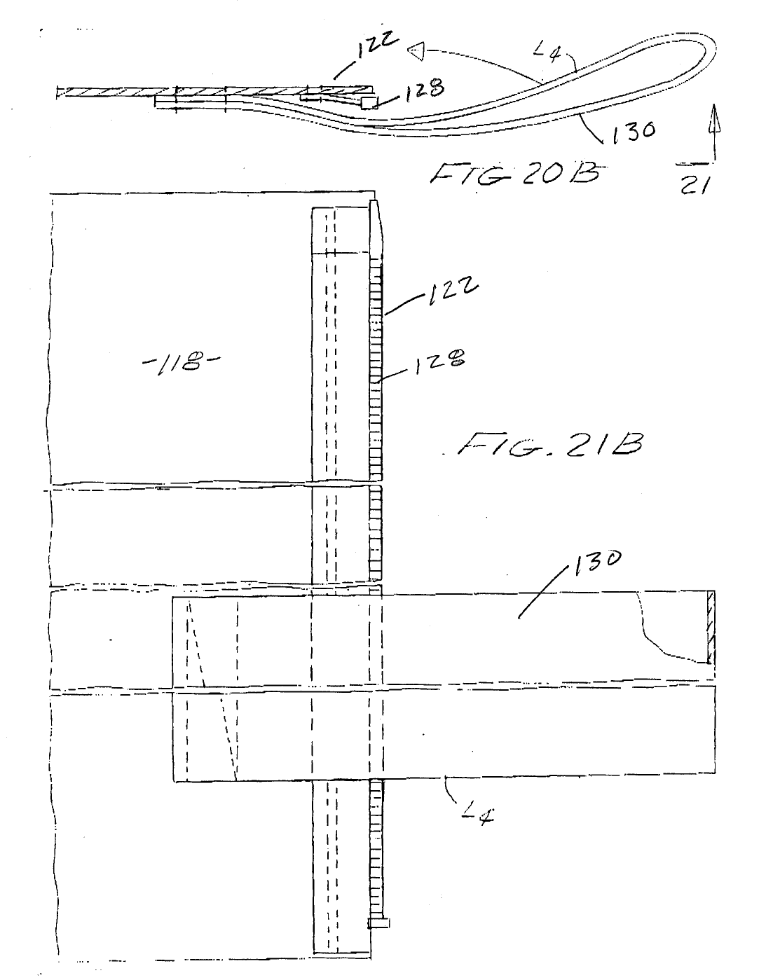

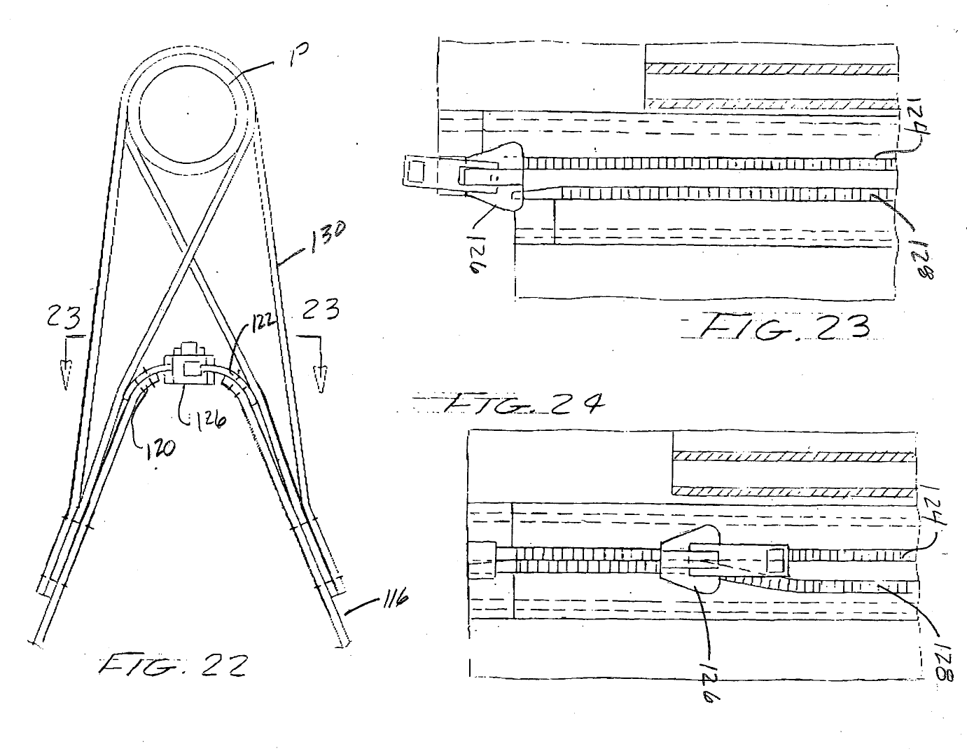

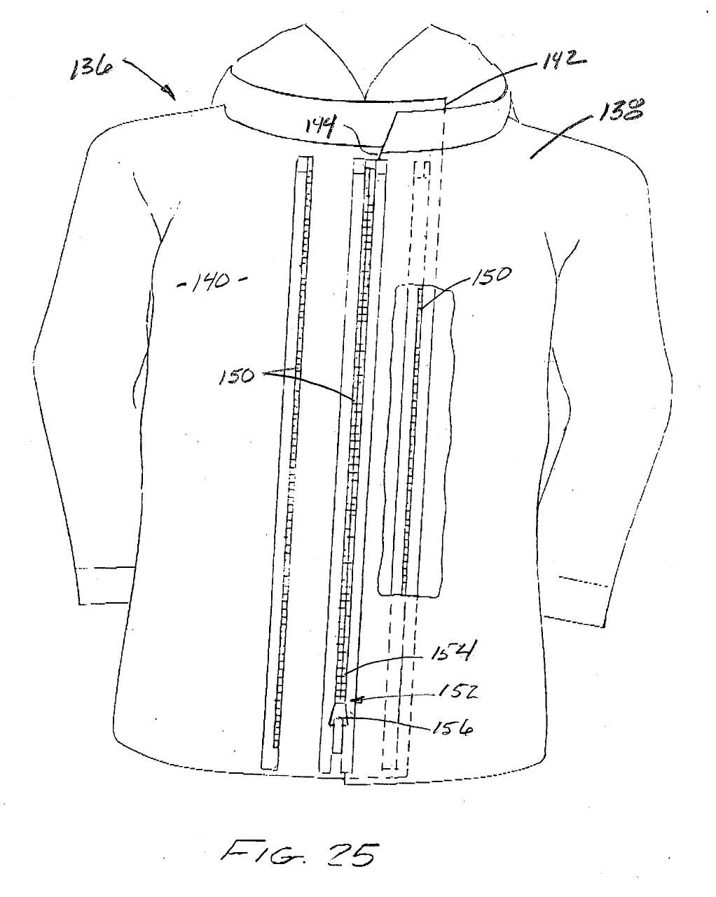

Turning next to FIGS. 18 through 24, yet another form of the modular panel system of the invention is there shown and generally designated by the numeral 116. Modular panel system 116 here comprises a modular panel 118 having flexible planar body portion 118a having front and back surfaces 58a and 58b respectively and transversely spaced apart edges 120 and 122. Positioned along each of the spaced apart edges 120 and 122 are reusable fastening means of the character previously described. As best seen in FIGS. 20A and 20B, the reusable fastening means provided on edge 120 comprise a conventional zipper track 124 and an operably associated, conventional zipper slider 126. Provided proximate edge 122 is a conventional zipper track 128 that can be interconnected with zipper track 124 in the manner shown in FIG. 19 to form the carrying structure there illustrated. Affixed to each of the edges 120 and 122 of modular panel 118 is a pair of lifting means for lifting the modular panel 118 and an object such as an individual I disposed thereon. This important lifting means is shown here as a pair of longitudinally spaced apart lifting loops 130 that are sewn to or otherwise affixed to modular panel 118 in the manner shown in the drawings. When the modular panel is in the flat configuration shown in FIG. 18 the panel and the article disposed thereon can be transported by grasping the lifting loops and raising and transporting the modular panel. If desired, elongated lifting poles can be inserted through the lifting loops 130 and gripped by one or more men located on either side of the modular panel to lift and transport the panel. Alternatively, the modular panel can be folded in the manner shown in FIG. 19 and the zipper tracks 124 and 128 interconnected using slider 126. With the assembly in this configuration, a lifting pole, such as a pole P, can be inserted through the lifting loops to enable men located at either end of the pole to conveniently lift and transport the modular panel assembly along with an individual or other cargo disposed interiorly of the folded modular panel identified in the drawings as conventional zipper tracks 64. Second reusable fastening means comprising zipper components, or tracks 64, are also positioned intermediate the spaced apart edges of the flexible planar body 58.

It to be understood that the modular panel system of this latest form of the invention can be used as an emergency stretcher to carry an individual such as individual I, or alternatively the system can be used to transport a number of different types of articles, such as machine parts, building materials and the like.

Referring next to FIG. 25, still another form of the modular panel system of the invention is there shown and generally designated by the numeral 136. Modular panel 136, which is somewhat is similar in construction to the previously described systems, here comprises a garment shaped modular panel 138 having a flexible planar body portion 140 having front and back surfaces and transversely spaced-apart edges 142 and 144. Positioned along edge 142 is a first reusable fastening means which includes a zipper track 146 and a conventional slider 148. Positioned intermediate spaced-apart edges 142 and 144 are reusable fastening means comprising zipper components, or tracks 150 of the same construction and operation as the earlier described zipper tracks 40.

In this latest form of the invention fastening means, which are provided on second edge 144 of panel 138, comprises a zipper component, generally designated by the numeral 152. Zipper component 152 includes a track 154 and a slider 156, which is operable in the same manner as the previously described slider 38. As illustrated in FIG. 25, a selected track 150 of panel 138 can be interconnected with track 154 through operation of slider 156 in the manner previously described and as illustrated in FIG. 25. It is apparent that by selecting a particular track 150, the size of the garment can be readily adjusted to fit snugly or loosely about the torso of the user.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A modular panel comprising:
(a) a flexible planar body having spaced apart edges;
(b) reusable fastening means positioned along at least one of said spaced apart edges of said flexible planar body; and
(c) a plurality of reusable fastening means positioned intermediate said spaced apart edges of said flexible planar body.

2. The modular panel as defined in claim 1 in which said flexible planar body has opposing first and second surfaces and in which said plurality of reusable fastening means are positioned on said first surface of said flexible planar body.

3. The modular panel as defined in claim 1 in which said flexible planar body has opposing first and second surfaces and in which said plurality of reusable fastening means are positioned on both said first and second surfaces of said flexible planar body.

4. The modular panel as defined in claim 1 in which said reusable fastening means comprises a zipper.

5. A modular panel comprising:
(a) a flexible planar body having opposing first and second surfaces and spaced apart edges;
(b) first reusable fastening means positioned along each of said spaced apart edges of said flexible planar body, said reusable fastening means comprising a zipper assembly; and
(c) a plurality of second reusable fastening means positioned intermediate said spaced apart edges of said flexible planar body.

6. The modular panel as defined in claim 5 in which said flexible planar body has opposing first and second surfaces and in which said plurality of second reusable fastening means are positioned on said first surface of said flexible planar body.

7. The modular panel as defined in claim 5 in which said flexible planar body has opposing first and second surfaces and in which said plurality of second reusable fastening means are positioned on both said first and second surfaces of said flexible planar body.

8. A modular panel comprising:
(a) a flexible planar body having spaced-apart edges;
(b) reusable fastening means positioned along each of said spaced-apart edges of said flexible planar body; and
(c) lifting means connected to said spaced-apart edges of said flexible planar body for lifting said modular panel.

9. The modular panel as defined in claim 8 in which said lifting means comprises a plurality of lifting loops connected to said flexible planar body.

10. The modular panel as defined in claim 8 in which said lifting means comprises a pair of lifting loops connected to each of said spaced-apart edges of said flexible planar body.

11. A modular panel system comprising:
(a) a first modular panel assembly comprising a flexible planar body having opposing first and second surfaces and transversely spaced-apart edges, are reusable fastening means positioned intermediate said spaced apart edges of said flexible planar body of said first modular panel assembly; and
(b) a second modular panel assembly removably connected to said first modular panel assembly, said second modular panel assembly comprising a flexible planar body having first and second spaced apart edges and reusable fastening means positioned along said first edge of said flexible planar body of said second modular panel assembly.

12. The modular panel as defined in claim 11 in which said first and second to reusable fastening means each comprises a zipper component.

13. The modular panel system as defined in claim 11 in which said first modular panel includes reusable fastening means positioned along at least one of said spaced-apart edges of said flexible planar body of said first modular panel.

14. The modular panel system as defined in claim 11 in which said second modular panel assembly further includes reusable fastening means positioned along said second edge of said flexible planar body of said second modular panel assembly.

15. The modular panel system as defined in claim 11 in which said second modular panel assembly further includes transversely spaced apart shoulder straps connected to said flexible planar body.

16. The modular panel system as defined in claim 11 in which said reusable fastening means positioned along said first edge of said flexible planar body of said second modular panel assembly is interconnectable with a selected one of said second fastening means of said first modular panel assembly.

17. The modular panel system as defined in claim 11 in which said first modular panel further includes a plurality of reusable second fastening means connected to said second surface of said first modular panel assembly.

18. The modular panel system as defined in claim 17 in which said reusable fastening means positioned along said first edge of said flexible planar body of said second modular panel assembly is interconnectable with a selected one of said fastening means of said first modular panel assembly that is connected to said second surface of said first modular panel assembly.
